(19) United States
(12) Patent Application Publication
(10) Pub. No.: US 2017/0255995 A1
(43) Pub. Date: Sep. 7, 2017

(54) FRAUD DETECTION SYSTEM

(71) Applicants: Chris Kay, Scottsdale, AZ (US); Abdu El-Shaarawy, Scottsdale, AZ (US); Keith Linneman, Scottsdale, AZ (US); Joel McKee Bowers, Apache Junction, AZ (US); Zachary Travis Olroyd, Phoenix, AZ (US)

(72) Inventors: Chris Kay, Scottsdale, AZ (US); Abdu El-Shaarawy, Scottsdale, AZ (US); Keith Linneman, Scottsdale, AZ (US); Joel McKee Bowers, Apache Junction, AZ (US); Zachary Travis Olroyd, Phoenix, AZ (US)

(73) Assignee: Blue Global, LLC, Scottsdale, AZ (US)

(21) Appl. No.: 15/060,128

(22) Filed: Mar. 3, 2016

(51) Int. Cl. G06Q 40/02; H04L 12/26

(52) U.S. Cl. CPC G06Q 40/025; H04L 43/14

(57) ABSTRACT

A system and method is disclosed for detecting fraudulent loan applications. The system is based upon multiple layers of detection in which anomalies are detected by analyzing the loan data and the borrower browser configuration for anomalies indicative of fraud. A plurality of fraud detection layers are used which when taken together provide a synergistic approach to detecting fraudulent data.

### BACKGROUND OF THE INVENTION

1. Field of the Invention

The present invention relates to a fraud detection system and method and more particularly to a fraud detection system that is based upon multiple layers of detection in which anomalies are detected by analyzing the loan data and the borrower browser configuration for anomalies indicative of fraud,

2. Description of the Prior Art.

Various methods have been used for a long time to detect fraudulent submissions of financial data. Fraud prevention in the financial lead generation industry continues to be a concern. Unscrupulous users commonly submit falsified applications. This is especially the case when operating an affiliate program that pays an incentive for each application submitted.

Techniques for fraud detection fall into two primary classes: statistical techniques and artificial intelligence. Statistical techniques include comparing data various statistical data. Artificial intelligence techniques include data mining of incoming data in order to associations and patterns in the data to automatically determine anomalies in the data indicative of fraud.

Examples of fraud detection systems are disclosed in US Patent Applications Publication Nos.: US 2015/0339671 A1; US 2015/0363791 A1; and US 2016/0012561; hereby incorporated by reference. The '671 and the '561 publications are examples of an artificial intelligence fraud detection system which compares customer input data with previously stored data regarding the customer, associations and patterns in the data to automatically determine anomalies in the data indicative of fraud. Any anomalies between customer input data and the previously stored customer data is indicated of potential fraud. The '791 publication is an example of a fraud detection system based upon statistical techniques. In this system, a statistical comparison of the incoming data against a statistical model in order to determine if the data is fraudulent.

Fraudsters go through great links to remain anonymous. Some of the detection avoidance techniques employed by these fraudsters include rotating through various proxy IP addresses to look like the applications are being submitted by different users in different geographical places. They will also forge the browser user agent text string that identifies the type of browser used to again look like different browsers are submitting the applications. As such current fraud detection methods are unable to provide consistent results.

Thus, there is a need to provide better systems for detecting fraud in loan applications.

### SUMMARY OF THE INVENTION

Briefly, the present invention relates to a system and method for identifying fraudulent loan application submissions multiple layers of detection in which anomalies are detected by analyzing the loan data and the borrower browser configuration for anomalies indicative of fraud. These layers of detection taken together add up to the sum being greater than its parts and allow a high degree of accuracy in detecting fraudulent behavior.

### DESCRIPTION OF THE DRAWING

These and other advantages of the present invention will be readily understood with reference to the following specification and attached drawing wherein:

FIG. 1A is a block diagram of a typical on-line loan application system illustrating fraudsters submitting fraudulent data to an on-line lender and to an on-line lender affiliate.

FIG. 1B is a simplified block diagram of system for processing loan applications.

FIG. 2 is a software flow diagram of one aspect of the invention relating to data change fraud detection.

FIG. 3 is a software flow diagram of one aspect of the invention relating to browser user agent mismatch.

FIG. 4 is a software flow diagram of one aspect of the invention relating to loan applications listing a time zone outside of the US.

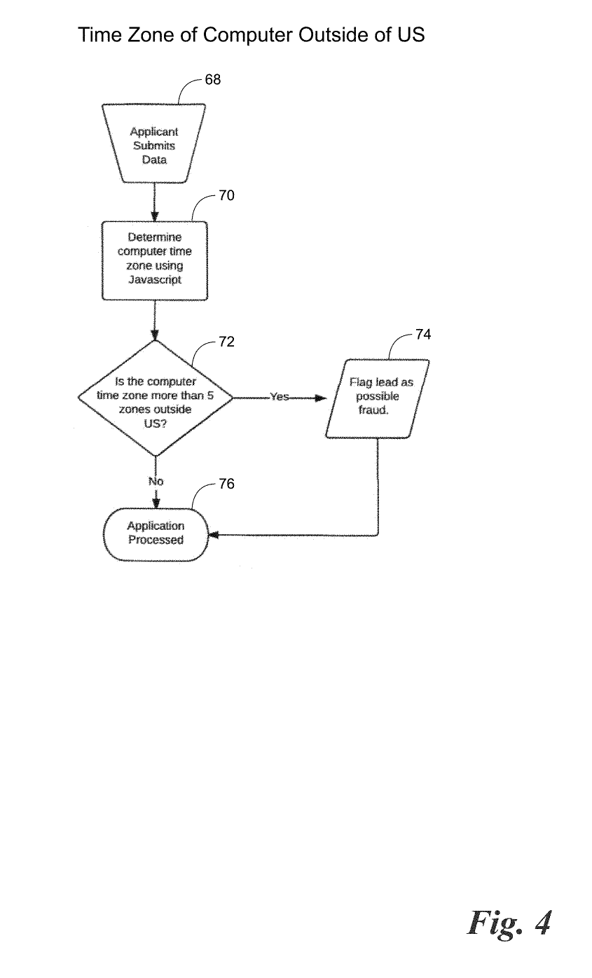

FIG. 5 is a software flow diagram of one aspect of the invention relating to loan applications in which the time zone of the loan application does not match the zip code listed in the application,

FIG. 6 a software flow diagram of one aspect of the invention relating to anomalies in the number key downs in the loan application.

FIG. 7 is a software flow diagram of one aspect of the invention relating to anomalies in the fingerprint of the application.

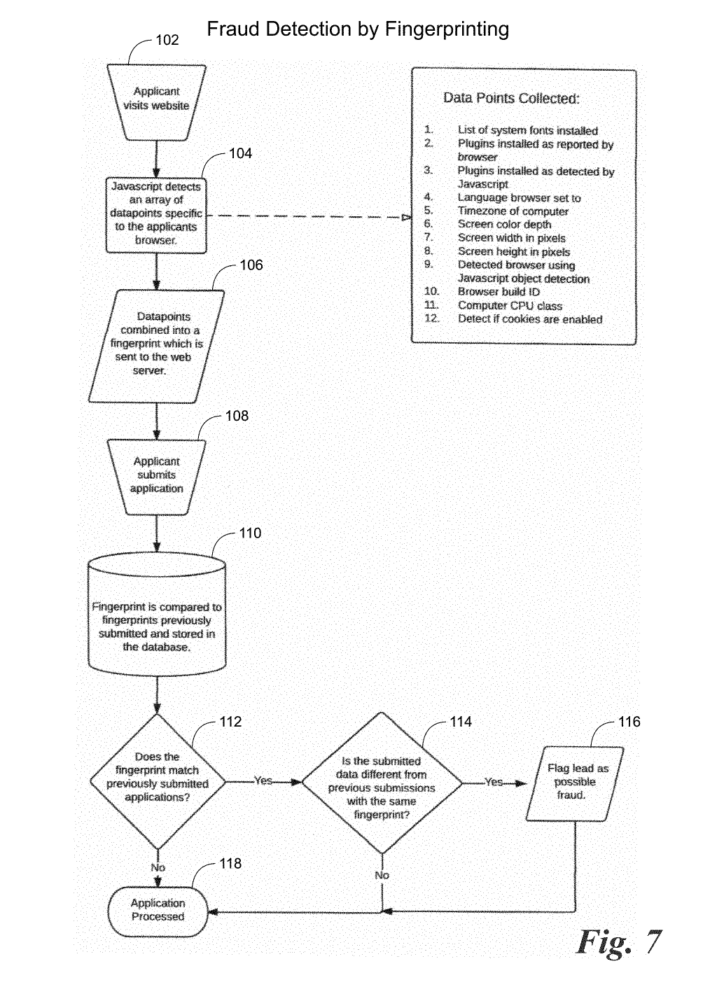

FIG. 8 is a software flow diagram of one aspect of the invention relating to duplicate user agent detection.

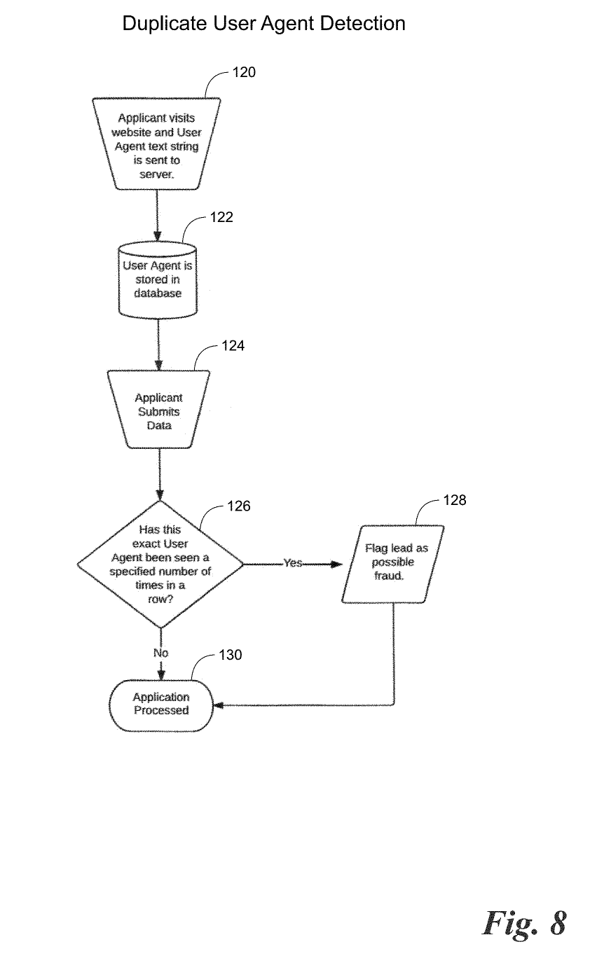

### DETAILED DESCRIPTION

The present invention relates to a method and system for detecting fraudulent on-line loan applications, The system utilizes multiple layers of detection in which anomalies are detected by analyzing the loan data and the configuration of the borrower's browser. A plurality of fraud detection layers are used which when taken together provide a synergistic approach to detecting fraudulent data.

Some known systems for detecting fraudulent loan applications center around detecting the IP address of the computer and the User Agent text string identifying the browser. These two pieces of data are often used in conventional fraud detection systems to if determine multiple loan application submissions are from the same computer. However, fraudsters are known to use proxies so that the IP address of the computer can be randomly rotated making it look like computers in different geographical areas are submitting the applications. In addition, Browser User Agent text strings can also be easily forged with common browser plugins widely available.

By using a combination of detection techniques, the system in accordance with the present invention can determine if the same computer is submitting applications even if proxies are in use and can detect if the User Agent text string is being forged.

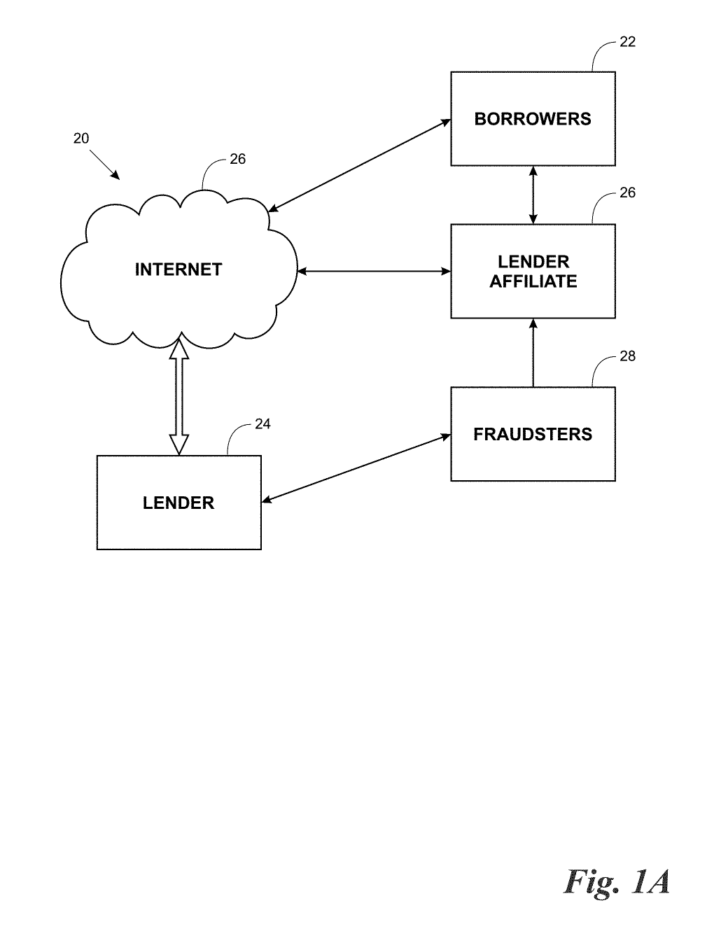

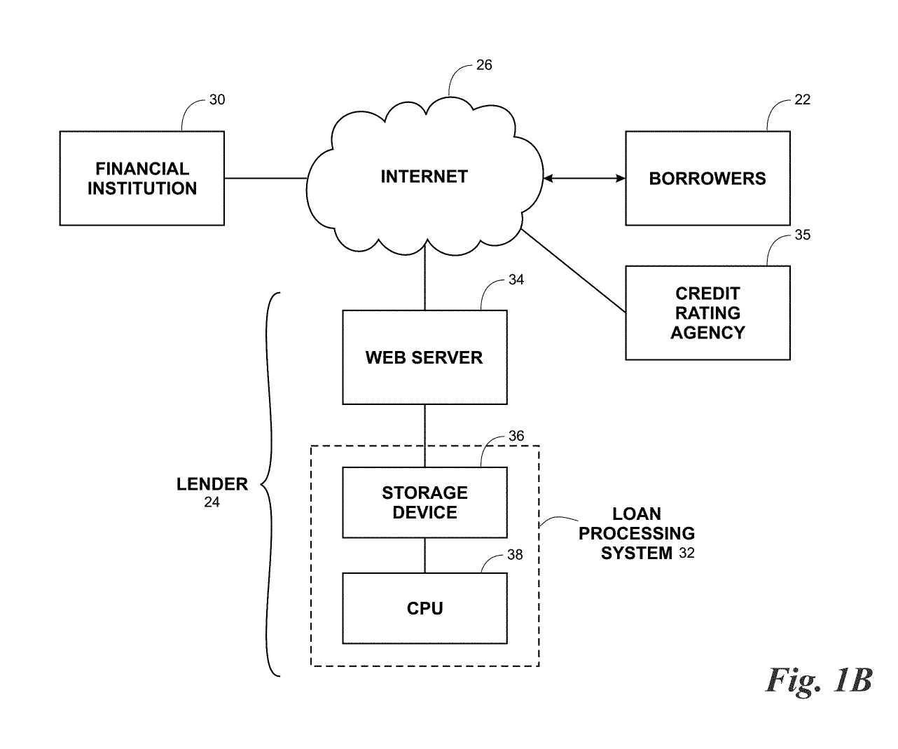

Referring first to FIG. 1, a block diagram of an on-line loan application system, generally illustrated by the reference numeral 20, is illustrated. Two different methods are illustrated for applying for a loan on-line: a direct method and an indirect method. In the direct method, borrowers 22 apply directly with an on on-line lender 24 over the Internet 26 by connecting to the lender's web site. In the indirect method borrowers apply for a loan by way of a web page of a lender affiliate 26, who in turn, directs the borrower to the lender. A lender affiliate is a performance based organization that is rewarded by the lender for each customer brought by the affiliate to the lender by way of the affiliates own marketing efforts.

Whether the loan is initiated as a directly or indirectly, the loan is managed by the lender's website. A prospective borrower fills out a loan application on either the lender affiliate's website or the lender's web site. The inputted data by the prospective borrower is processed by the lender's web site. On-line loan applications are unsecured short term loans for relatively small amounts. Normally after a simple credit check, the money requested by the borrower is deposited in the borrower's bank account.

FIG. 1B is a simplified block diagram of a loan processing system. Loan applications are completed by borrowers 22 connected to the lender's web server 34. The data in the loan application is processed by a loan processing system 32. The loan processing system 32 includes a computer processing unit (CPU) 38 and a persistent storage device 36 that may include an internal or external database. Data from loan applications is received and stored in the persistent storage device, 36. For legitimate loan transactions, this data is processed by the CPU 38 which processes the loan data in accordance with conventional and customary loan processing techniques which normally includes checking the borrower's credit score at one or more credit rating agencies 35 in order to arrive at a an annual percentage rate (APR) for the loan, Once the lender 24 decides to make the loan, the money requested for the loan is transferred by way of electronic funds transfer to the borrower's account at the borrower's financial institution 30.

In addition to the normal loan processing techniques, the system and method in accordance with the present invention utilizes multiple layers of fraud detection techniques to identify fraudulent loan applications. Utilization of multiple layers of fraud detection techniques produces a synergistic effect which provides better results than any of the fraud detection techniques individually.

In general, the present invention utilizes two or more of the following fraud detection techniques, as described below:
Data Change Fraud Detection
Duplicate Browser User Agents
Browser User Agent Mismatch
Time Zone of Computer Outside the US
Time Zone of Computer Does Not Match Time Zone of Zip Code
Detecting Number of Key Downs When Completing Application
Browser Fingerprinting

### DATA CHANGE FRAUD DETECTION

When submitting multiple fraudulent applications, fraudsters are known to retain certain key pieces of data consistently across all fraudulent submissions. If multiple applications have these pieces of data in common but the rest of the application is unique, this is an indication of fraud. As such, the system checks various pieces of data for commonality among loan applications, for example, IP address, email address and phone number.

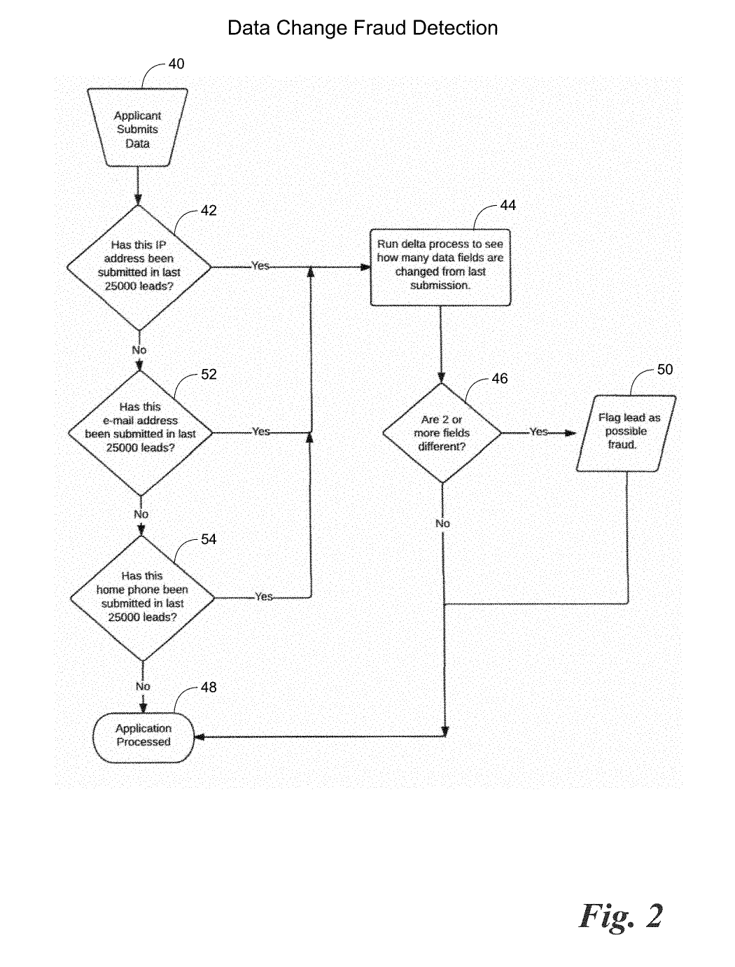

With reference to FIG. 2, an exemplary method of data change fraud detection is illustrated. In this method, once loan application is submitted in step 40, the loan processing system 32 checks whether the IP address (IP Address being the Internet location of the applicants computer) of the computer submitting the loan application has submitted previous applications in a predetermined number of submissions, for example, 25,000 leads in step 42. The commonality of IP address shared by multiple application submissions indicates that loan applications submitted from the same computer may be fraudulent.

If the computer submitting the loan application has an IP address that matches an IP address in the last predetermined number of submissions, the system checks the data fields of the loan application and compares the data in those fields with the data in the data fields of the previous loan applications in step 44. If the data in all of the data fields in the new loan application is the same as the data in a previously filed applications, as determined in step 46, the application is assumed to be a duplicate or previous loan application by a legitimate borrower and the loan application is passed on to step 48 for loan processing.

On the other hand, if it is determined in step 46 that the data in the data fields in the new loan application is the same as the data in a previously filed loan application except for some but not all data fields, for example, 2 or more fields, the system flags the loan application in step 50 as possibly fraudulent before it is processed in step 48.

If the system determines in step 42 that the IP address of the current loan application has not been used in the last predetermined number of applications, the system checks in step 52 the email address of the submitter. Email addresses of the borrowers 22 are used by lenders 24 to communicate with the borrower various information regarding the loan, such as, whether the loan is approved and based upon various data, for example, the borrower's credit score, the APR; and terms for the loan. Multiple applications with the same e-mail address, in which all other data is unique, is an indicator that all applications are from the same applicant with falsified information.

If the email address used on the loan application has been used on previous loan applications, for example, the past 25,000 applications, the system proceeds to steps 44 and 46, as discussed above. If the email address on the loan application has not been used in a predetermined number of previous applications, for example, 25,000 applications, the system proceeds to step 54 and determines whether the home phone number listed on the patent application has been used in previous applications, for example, the previous 25,000 applications. Multiple applications with the same phone number but with all other data being unique, is an indicator that all applications are from the same applicant with falsified information. If so, the system proceeds to steps 44 and 46, as discussed above. If not, the system proceeds to step 48 for processing,

### BROWSER USER AGENT MISMATCH

When sending a request over the Internet to a website server, all browsers include a text string in the HTTP header called a User Agent that identifies the type of browser making the request. This User Agent text string is somewhat unique to each computer making the web request. If multiple application submissions are accompanied by the exact same User Agent text string but with different application data, this is an indicator of fraud.

The User Agent text string identifying the browser type can easily be forged, and, in fact, fraudsters are known to commonly rotate through various User Agent text strings to make it appear that applications are being submitted from different browsers. Using Javascript object detection, the type of browser can also be determined. This is due to Javascript being implemented with slight differences depending on the browser type, Javascript object detection is difficult to forge and is in general not well known, By comparing the browser type identified by the User Agent text string to the browser identified by Javascript object detection, forged User Agent text strings can be identified. Forged User Agent text strings is a very strong indicator of fraud.

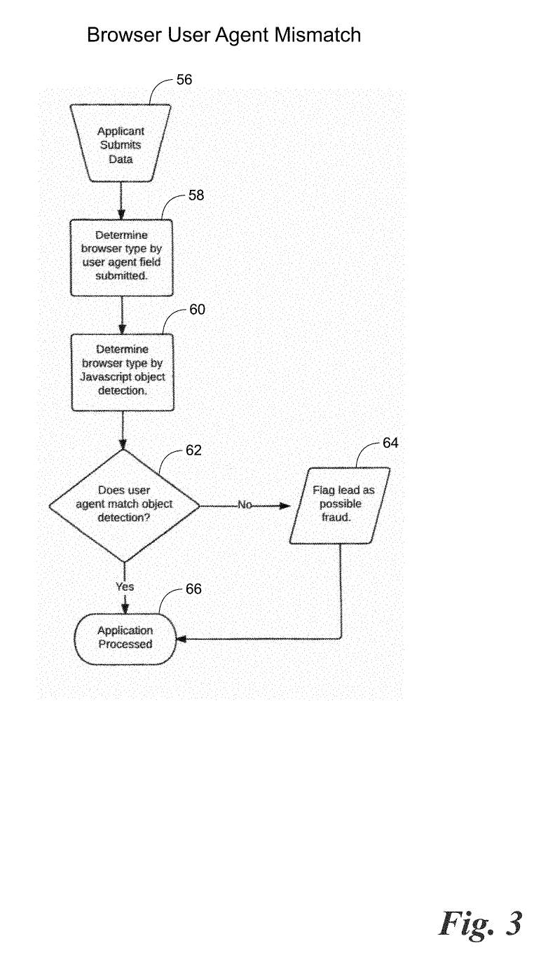

Referring to FIG. 3, the system checks the browser agent of loan data submitted in step 56. In step 58, the system determines the browser type by examining the user agent field transmitted with the loan application. In step 60, the system checks the browser type by Java object detection. In step 62, the system checks whether user agent the browser agent determined in step 60 match. If not, the system is flagged in step 64 as a possible fraudulent application before being processed in step 66. If the user agent matches the object detection, the application is processed in step 66.

### TIME ZONE OUTSIDE OF THE US

For financial institutions that only deal with US based applicants, applications submitted from outside the US can be indicative of fraud. Javascript can be used to determine the time zone of the computer submitting the application. If the time zone detected is outside of any US time zone, yet the application data submitted states the applicant is in the US, this indicates fraud.

In step 70, the system determines the time zone of the computer that submitted the application in step 68. In step 72, the system determines if the time zone of the computer submitting the application is in a time zone that is in a foreign country or in a time zone outside of the time zones outside of the time zones where the lender 24 does business, for example, 5 or more time zones outside the US. If so, the loan application is flagged as a possible fraudulent application in step 74 before the loan is processed in step 76.

### TIME ZONE OF COMPUTER DOES NOT MATCH TIME ZONE OF SUBMITTED ZIP CODE IN APPLICATION

When submitting a US zip code as part of the application data, the time zone of that zip code can be easily determined. By comparing the time zone of the zip code with the time zone of the computer used to make the application submission, a discrepancy can be detected. Fraudsters submitting fraudulent data are to known to submit addresses and zip codes ranging across the US. If the time zone of the submitted zip code does not match the time zone of the computer used to submit the application, this is an indicator of fraud.

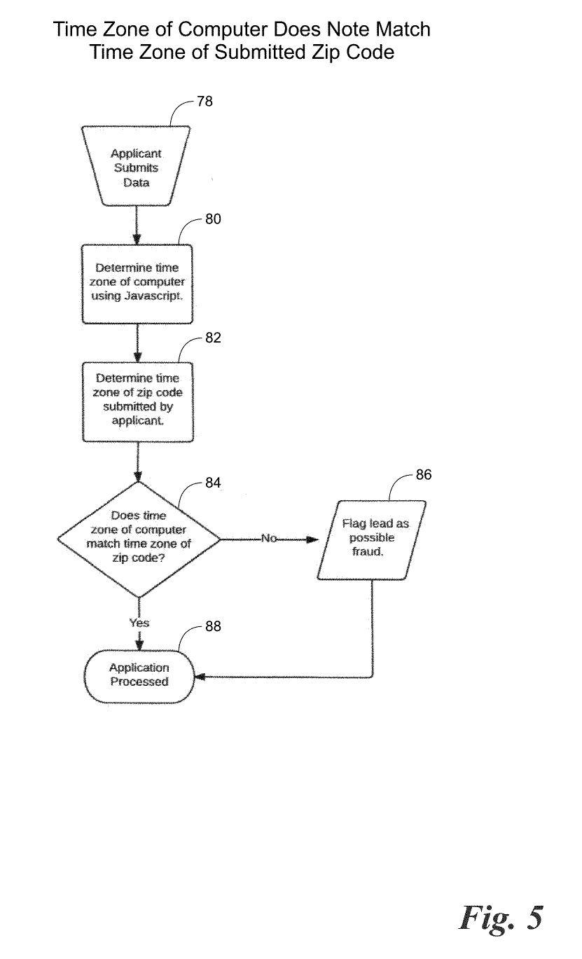

Referring to FIG. 5, the system determines the time zone of the computer using Javascript in step 80 for the applications received in step 78. In step 82, the system checks the time zone of the zip code submitted on the loan application. This time zone is compared with the time zone of the computer in step 84. If the time zones do not match, the system is flagged as a possible fraudulent application in step 86 and processed accordingly in step 88. If the system determines in step 84, the application is processed in step 88.

### DETECTING NUMBER OF KEY DOWNS WHEN COMPLETING APPLICATION

When entering data into an application form, a legitimate user will generally type in each of the form fields. However, a fraudster will more likely use some automated means of filling out the form. Using Javascript, the number of times a key is pressed entering data into a form field can be determined. If there are only a few key downs detected compared to the number of fields on the form, this can be an indicator of form auto-completion, which is an indicator of fraud.

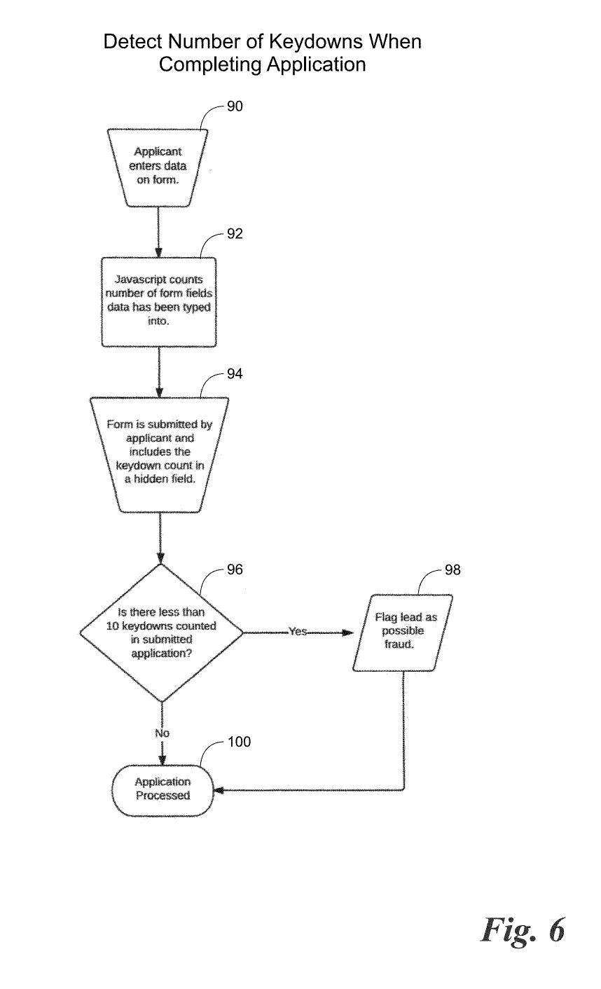

Referring to FIG. 6, the system checks for the number of key downs in the applications. In particular, the system uses Javascript to determine the number of key strokes used to complete the application in step 92 for the applications submitted in step 90. The metadata submitted with the loan application includes the number of key downs. The system reads the key downs in step 94. In step 96, the system determines if the number of key strokes in the meta data transmitted with the application is less than a predetermined number of key strokes, for example 10. If the number of key downs is less than said predetermined number, the loan application is flagged in step 98 as a possible fraudulent application before the application is processed in step 100.

### BROWSER FINGER PRINTING

Detecting that the same computer is submitting multiple applications with different data is a strong indicator of fraud. Individual browsers generally are not configured exactly the same. By detecting various data points related to the browser's configuration, a fingerprint can be generated identifying the individual browser. Multiple submissions of applications with different data from browsers having the same fingerprint is an indicator that the data is being submitted from the same computer and therefore may be fraudulent.

In step 104, the system collects various data points from the submitter's web browser to create a fingerprint of the submitter's browser when the submitter logs onto the lender's website in step 102. These exemplary data points can be detected using Javascript and include the following:
List of system fonts installed on the computer.
Plugins installed as reported by the browser.
Plugins installed as detected by Javascript.
The language that the browser and computer are set to.
The time zone of the computer.
The screen color depth of the computer display.
The screen width in pixels of the computer display.
The screen height in pixels of the computer display.
The type of browser as detected by Javascript object detection.
The browser build ID as reported by the browser.
The computer CPU class as reported by the browser.
Detection of cookies being enabled or disabled for the browser.

In step 106, one or more of the data points may be combined into an exemplary fingerprint which is sent to the web server 34. The exemplary fingerprint may be constructed by taking all the data points generated by Java Script detection, stringing them all together each separated by a ˜ and then taking an SHA1 Hash of that to create a unique identifier for that particular combination of data points. The SHA1 hash is a 40 character string called a message digest and is known in the art.

Taken together, these fraud detection techniques can identify submission patterns by individual users indicating they are submitting fraudulent applications. Once the submitter submits a loan application in step 108, the fingerprint from the submitter's browser is compared with previously stored and submitted finger prints stored in a data base in step 110. In step 112, the system checks in step 112 whether the fingerprint of the submitter's browser matches the browser fingerprints of any previously submitted loan applications. If so, the system checks in step 114 whether data in other loan applications with the same fingerprint is different, for example, as discussed above. If so, the application flags the application as potentially fraudulent in step 116 before the application is processed in step 118. If not, the application is processed in step 118.

### DUPLICATE USER AGENT DETECTION

Another method of fraud detection relates to checking the number of times in a row a user agent is detected on multiple loan applications. As mentioned above, a user agent is a text string that identifies the user agent. This text string is sent to the web server 34 when a submitter logs onto the lender's website, as indicated in step 120. This text string representative is stored in a database in step 122. In step 126, the system checks whether the user agent has been sent a specified number of times in a row. If so, the application is flagged as being potentially fraudulent in step 128 before the application is processed in step 130. If not, the loan application is processed in step 130.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

We claim:

1. A method of detecting fraudulent loan applications filed on line at a lender's website, the method comprising the steps of:
(a) determining the configuration of the borrower's web browser logged into the lender's website; and
(b) determining if there are anomalies in the identification of the borrower's web browser configuration;
(c) determining if there are anomalies in the data in the loan application; and
(d) flagging the application as fraudulent if any anomalies are detected.

2. The method as recited in claim 1, wherein step (b) includes the step of determining whether the user agent matches the object detection of the browser configuration and indicating a fraudulent application if the user agent does not match the object detection.

3. The method as recited in claim 1, wherein step (b) includes the step of checking the user agent to determine if it has been used in a predetermined submittals in a row and indicating a fraudulent application if the user agent has been used a predetermined number of times in a row.

4. The method as recited in claim 1, wherein step (c) includes the step of checking the IP address of the browser that is logged into lender's web site and checking whether the IP address has been submitted in the last predetermined number of submittals and indicating an anomaly if only a predetermined number of data fields have changed since the last submittal.

5. The method as recited in claim 1, wherein step (c) includes the step of checking the email address in the loan application and checking whether the email address has been included in the last predetermined number of submittals and indicating an fraudulent application if only a predetermined number of data fields have changed since the last submittal.

6. The method as recited in claim 1, wherein step (c) includes the step of checking the phone number in the loan application and checking whether the phone number has been included in the last predetermined number of submittals and indicating a fraudulent application if only a predetermined number of data fields have changed since the last submittal.

7. The method as recited in claim 1, wherein step (c) includes the step of checking the computer time zone of the browser connected to the lender's website and indicating a fraudulent application for predetermined time zones.

8. The method as recited in claim 1, wherein step (c) includes the step of checking the computer time zone of the browser connected to the lender's website and indicating a fraudulent application if the time zone does not match the time zone of the zip code in the loan application.

9. The method as recited in claim 1, wherein step (c) includes the step of checking the key downs in the submitted application and indicating a fraudulent application if the key downs are less than a predetermined number.

10. The method as recited in claim 1, wherein step (c) includes the step of creating a fingerprint of one or more characteristics of the browser logged into the lender's website and comparing the fingerprint to previously stored fingerprints and comparing the data of the current loan application with the data in the matching fingerprint and indicating a possible fraudulent application if the data is different.

11. A system for detecting fraudulent loan applications filed on line at a lender's website, the system configured to:
(a) determine the configuration of the borrower's web browser logged into the lender's website; and
(b) determine if there are anomalies in the identification of the borrower's web browser configuration;
(c) determine if there are anomalies in the data in the loan application; and
(d) flag the application as fraudulent if any anomalies are detected.
